(19) United States
(12) Patent Application Publication
(10) Pub. No.: US 2022/0084506 A1
(43) Pub. Date: Mar. 17, 2022

(54) SPOKEN SENTENCE GENERATION MODEL LEARNING DEVICE, SPOKEN SENTENCE COLLECTING DEVICE, SPOKEN SENTENCE GENERATION MODEL LEARNING METHOD, SPOKEN SENTENCE COLLECTION METHOD, AND PROGRAM

(71) Applicant: NIPPON TELEGRAPH AND TELEPHONE CORPORATION, Tokyo (JP)

(72) Inventors: Ko MITSUDA, Tokyo (JP); Junji TOMITA, Tokyo (JP); Ryuichiro HIGASHINAKA, Tokyo (JP); Taichi KATAYAMA, Tokyo (JP)

(73) Assignee: NIPPON TELEGRAPH AND TELEPHONE CORPORATION, Tokyo (JP)

(21) Appl. No.: 17/418,188

(22) PCT Filed: Dec. 17, 2019
(86) PCT No.: PCT/JP2019/049395

§ 371 Date: Jun. 24, 2021

(30) Foreign Application Priority Data
Dec. 26, 2018 (JP) 2018-242422

(51) Int. Cl. G10L 15/08

(52) U.S. Cl. CPC G10L 15/08

(57) ABSTRACT

It is intended to allow learning of a spoken sentence generation model for generating a spoken sentence which enables a discussion covering a wide range of topics. A discussion data storage unit 100 stores a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence. A learning unit 130 learns, on the basis of the discussion spoken sentences and the approving spoken sentences that are included in the plurality of discussion data sets, an approving spoken sentence generation model which receives, as an input thereto, a spoken sentence and generates the approving spoken sentence for the spoken sentence and also learns, on the basis of the discussion spoken sentences and the disapproving spoken sentences that are included in the plurality of discussion data sets, a disapproving spoken sentence generation model which receives, as an input thereto, the spoken sentence and generates the disapproving spoken sentence for the spoken sentence.

### TECHNICAL FIELD

The present invention relates to a spoken sentence generation model learning device, a spoken sentence collecting device, a spoken sentence generation model learning method, a spoken sentence collection method and a program, and in particular, to a spoken sentence generation model learning device, a spoken sentence collecting device, a spoken sentence generation model learning method, a spoken sentence collection method, and a program, each for generating a spoken sentence in a dialogue system.

### BACKGROUND ART

In a dialogue system, a human being interacts with a computer to obtain various information or satisfy a demand.

There is also a dialogue system with which not only a predetermined task is completed, but also everyday conversation is performed. With such dialogue systems, a human being obtains mental stability, satisfies his or her need for approval, or establishes a reliable relationship.

NPL 1 describes types of such dialogue systems in detail.

Meanwhile, a research for causing a computer to perform a discussion, not task completion nor everyday conversation is also pursued. Discussions serve to change value judgments made by human beings or organize human thoughts, and has an important function for the human beings.

For example, in NPL 2, using graph data having opinions as nodes, a sentence spoken by a user is mapped to one of the nodes, and the node in connected relation with the mapping destination node is returned as a system spoken sentence to the user to effect a discussion.

Graph data is manually produced on the basis of a pre-set discussion topic (e.g., “A city is a better place to settle down than a countryside”). By using manually produced discussion data, it is possible to discuss about a specified topic.

### CITATION LIST

### Non-Patent Literature

[NPL 1] Tatsuya Kawahara, “A Brief History of Spoken Dialogue Systems—Evolution and Recent Technical Trend—” Journal of Japanese Society for Artificial Intelligence, Vol. 28, No. 1, 2013, pp 45-51.
[NPL 2] Ryuichiro Higashinaka et al., “Argumentative dialogue system based on argumentation structures”, Proceedings of The 21st Workshop on the Semantics and Pragmatics of Dialogue, 2017, pp 154-155.

### SUMMARY OF THE INVENTION

### Technical Problem

However, such a dialogue system as proposed in NPL 2 has a problem in that, while allowing a profound discussion to be made about a specified topic (closed domain), the dialogue system cannot appropriately respond to a user spoken sentence deviating from the pre-set specific discussion topic.

To solve this problem, an approach is considered in which graph data for a discussion about any given topic is produced in advance. However, since there are countless discussion topics, the approach is not realistic.

The present invention is achieved in view of the point described above, and an object of the present invention is to provide a spoken sentence generation model learning device, a spoken sentence generation model learning method, and a program that allow learning of a spoken sentence generation model for generating a spoken sentence which enables a discussion covering a wide range of topics.

Another object of the present invention is to provide a spoken sentence collecting device, a spoken sentence collection method, and a program that allow efficient collection of discussion data sets for learning a spoken sentence generation model that generates a spoken sentence which enables a discussion covering a wide range of topics.

### Means for Solving the Problem

A spoken sentence generation model learning device according to the present invention is configured to include: a discussion data storage unit storing a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence, the discussion spoken sentence, the approving spoken sentence, and the disapproving spoken sentence being in the same format; and a learning unit that learns, on the basis of the discussion spoken sentences and the approving spoken sentences that are included in the plurality of discussion data sets, an approving spoken sentence generation model which receives, as an input thereto, a spoken sentence and generates the approving spoken sentence for the spoken sentence and also learns, on the basis of the discussion spoken sentences and the disapproving spoken sentences that are included in the plurality of discussion data sets, a disapproving spoken sentence generation model which receives, as an input thereto, the spoken sentence and generates the disapproving spoken sentence for the spoken sentence.

The present invention provides a spoken sentence generation model learning method wherein a discussion data storage unit stores a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence, and a learning unit learns, on the basis of the discussion spoken sentences and the approving spoken sentences that are included in the plurality of discussion data sets, an approving spoken sentence generation model which receives, as an input thereto, a spoken sentence and generates the approving spoken sentence for the spoken sentence and also learning, on the basis of the discussion spoken sentences and the disapproving spoken sentences that are included in the plurality of discussion data sets, a disapproving spoken sentence generation model which receives, as an input thereto, the spoken sentence and generates the disapproving spoken sentence for the spoken sentence.

With the spoken sentence generation model learning device and the spoken sentence generation model learning method according to the present invention, the discussion data storage unit stores the plurality of discussion data sets each including the discussion spoken sentence indicating the discussion topic and the pair of the approving spoken sentence indicating approval for the discussion spoken sentence and the disapproving spoken sentence indicating disapproval for the discussion spoken sentence, and the learning unit learns, on the basis of the discussion spoken sentences and the approving spoken sentences that are included in the plurality of discussion data sets, the approving spoken sentence generation model which receives, as the input thereto, the spoken sentence and generates the approving spoken sentence for the spoken sentence and also learning, on the basis of the discussion spoken sentences and the disapproving spoken sentences that are included in the plurality of discussion data sets, the disapproving spoken sentence generation model which receives, as the input thereto, the spoken sentence and generates the disapproving spoken sentence for the spoken sentence.

Thus, the plurality of discussion data sets each including the discussion spoken sentence indicating the discussion topic and the pair of the approving spoken sentence indicating the approval for the discussion spoken sentence and the disapproving spoken sentence indicating the disapproval for the discussion spoken sentence are stored, and the approving spoken sentence generation model which receives, as the input thereto, the spoken sentence and generates the approving spoken sentence for the spoken sentence is learned on the basis of the discussion spoken sentences and the approving spoken sentences that are included in the plurality of discussion data sets, while the disapproving spoken sentence generation model which receives, as the input thereto, the spoken sentence and generates the disapproving spoken sentence for the spoken sentence is learned on the basis of the discussion spoken sentences and the disapproving spoken sentences that are included in the plurality of discussion data sets. This allows a spoken sentence generation model for generating a spoken sentence which enables a discussion covering a wide range of topics to be learned.

In the spoken sentence generation model learning device according to the present invention, the format of each of the discussion spoken sentence, the approving spoken sentence, and the disapproving spoken sentence can be a format in which a noun equivalent, a particle equivalent, and a predicate equivalent are combined.

A spoken sentence collecting device according to the present invention includes: a discussion spoken sentence input screen presenting unit that presents a screen for a worker to input a discussion spoken sentence indicating a discussion topic; a discussion spoken sentence input unit that receives the input discussion spoken sentence; an approving spoken sentence/disapproving spoken sentence input screen presenting unit that presents a screen for the worker to input an approving spoken sentence indicating approval for the input discussion spoken sentence and a disapproving spoken sentence indicating disapproval for the discussion spoken sentence; an approving spoken sentence/disapproving spoken sentence input unit that receives the input approving spoken sentence and the input disapproving spoken sentence; and a discussion data storage unit that stores a discussion data set including the input discussion spoken sentence and a pair of the approving spoken sentence for the discussion spoken sentence and the disapproving spoken sentence for the discussion spoken sentence. The discussion spoken sentence, the approving spoken sentence, and the disapproving spoken sentence can be in the same format.

The present invention provides a spoken sentence collection method wherein a discussion spoken sentence input screen presenting unit presents a screen for a worker to input a discussion spoken sentence indicating a discussion topic, a discussion spoken sentence input unit receives the input discussion spoken sentence, an approving spoken sentence/disapproving spoken sentence input screen presenting unit presents a screen for the worker to input an approving spoken sentence indicating approval for the input discussion spoken sentence and a disapproving spoken sentence indicating disapproval for the discussion spoken sentence, an approving spoken sentence/disapproving spoken sentence input unit receives the input approving spoken sentence and the input disapproving spoken sentence, and a discussion data storage unit stores a discussion data set including the input discussion spoken sentence and a pair of the approving spoken sentence for the discussion spoken sentence and the disapproving spoken sentence for the discussion spoken sentence. The discussion spoken sentence, the approving spoken sentence, and the disapproving spoken sentence can be in the same format.

With the spoken sentence collecting device and the spoken sentence collection method according to the present invention, the discussion spoken sentence input screen presenting unit presents the screen for the worker to input the discussion spoken sentence indicating the discussion topic, the discussion spoken sentence input unit receives the input discussion spoken sentence, the approving spoken sentence/disapproving spoken sentence input screen presenting unit presents the screen for the worker to input the approving spoken sentence indicating approval for the input discussion spoken sentence and the disapproving spoken sentence indicating disapproval for the discussion spoken sentence, and the approving spoken sentence/disapproving spoken sentence input unit receives the input approving spoken sentence and the input disapproving spoken sentence.

In addition, the discussion data storage unit stores the discussion data set including the input discussion spoken sentence and the pair of the approving spoken sentence for the discussion spoken sentence and the disapproving spoken sentence for the discussion spoken sentence, and the discussion spoken sentence, the approving spoken sentence, and the disapproving spoken sentence are in the same format.

Thus, the screen for the worker to input the discussion spoken sentence indicating the discussion topic is presented, the input discussion spoken sentence is received, the screen for the worker to input the approving spoken sentence indicating the approval for the input discussion spoken sentence and the disapproving spoken sentence indicating the disapproval for the discussion spoken sentence is presented, the input approving spoken sentence and the input disapproving spoken sentence are received, the discussion data set including the input discussion spoken sentence and the pair of the approving spoken sentence for the discussion spoken sentence and the disapproving spoken sentence for the discussion spoken sentence is stored, and the discussion spoken sentence, the approving spoken sentence, and the disapproving spoken sentence are in the same format. This allows efficient collection of the discussion data sets for learning a spoken sentence generation model that generates a spoken sentence which enables a discussion covering a wide range of topics.

A program according to the present invention is a program for causing a computer to function as each of the units of the spoken sentence generation model learning device or spoken sentence collecting device described above.

### Effects of the Invention

The spoken sentence generation model learning device, the spoken sentence generation model learning method, and the program according to the present invention allow learning of the spoken sentence generation model for generating the spoken sentence which enables a discussion covering a wide range of topics.

In addition, the spoken sentence collecting device, the spoken sentence collection method, and the program according to the present invention allow efficient collection of the discussion data sets for learning the spoken sentence generation model that generates the spoken sentence which enables a discussion covering a wide range of topics.

### BRIEF DESCRIPTION OF DRAWINGS

FIG. 1 is a schematic diagram illustrating a configuration of a spoken sentence generating device according to an embodiment of the present invention.

FIG. 2 is a schematic diagram illustrating a configuration of a spoken sentence collecting device according to the embodiment of the present invention.

FIG. 3 is a diagram illustrating an example of speeches to be collected according to the embodiment of the present invention.

FIG. 4 is a conceptual view illustrating an example of speeches produced by each of workers for crowdsourcing and a procedure thereof according to the embodiment of the present invention.

FIG. 5 is a diagram illustrating an example of a file in which discussion speeches according to the embodiment of the present invention are listed.

FIG. 6 is a diagram illustrating an example of a file in which approving speeches according to the embodiment of the present invention are listed.

FIG. 7 is a diagram illustrating an example of a file (word-segmented) in which the discussion speeches according to the embodiment of the present invention are listed.

FIG. 8 is a diagram illustrating an example of a file (word-segmented) in which approving speeches according to the embodiment of the present invention are listed.

FIG. 9 is a diagram illustrating an example of a command to produce a spoken sentence generation model according to the embodiment of the present invention.

FIG. 10 is a diagram illustrating an example of an approving spoken sentence generation model to be produced according to the embodiment of the present invention.

FIG. 11 is a diagram illustrating an example of a user speech to be input according to the embodiment of the present invention.

FIG. 12 is a diagram illustrating an example in which the input user speech is word-segmented according to the embodiment of the present invention.

FIG. 13 is a diagram illustrating an example of a command for generating the approving speeches and disapproving speeches according to the embodiment of the present invention.

FIG. 14 is a diagram illustrating an example of an output of the approving spoken sentence generation model according to the embodiment of the present invention.

FIG. 15 is a diagram illustrating an example of an output of a disapproving spoken sentence generation model according to the embodiment of the present invention.

FIG. 16 is a diagram illustrating an example of the output of the disapproving spoken sentence generation model according to the embodiment of the present invention.

FIG. 17 is a flowchart illustrating a spoken sentence collection processing routine for the spoken sentence collecting device according to the embodiment of the present invention.

FIG. 18 is a flowchart illustrating a spoken sentence generation model learning processing routine for the spoken sentence generating device according to the embodiment of the present invention.

FIG. 19 is a flowchart illustrating a spoken sentence generation processing routine for the spoken sentence generating device according to the embodiment of the present invention.

### DESCRIPTION OF EMBODIMENTS

Using the drawings, a description will be given below of an embodiment of the present invention.

<Outline of Spoken Sentence Generating Device According to Embodiment of Present Invention>

A spoken sentence generating device according to the embodiment of the present invention receives, as an input thereto, any user spoken sentence as a text and outputs, as a system spoken system and as a text, an approving spoken sentence indicating approval for the user spoken sentence and a disapproving spoken sentence indicating disapproval for the user spoken sentence.

For each of the approving spoken sentence and the disapproving spoken sentence, M (M is an arbitrary number) outputs with higher certainty factors can be produced.

The spoken sentence generating device uses a discussion data set collected by crowdsourcing to learn a spoken sentence generation model and generate a spoken sentence on the basis of the learned spoken sentence generation model

<Configuration of Spoken Sentence Generating Device According to Embodiment of Present Invention>

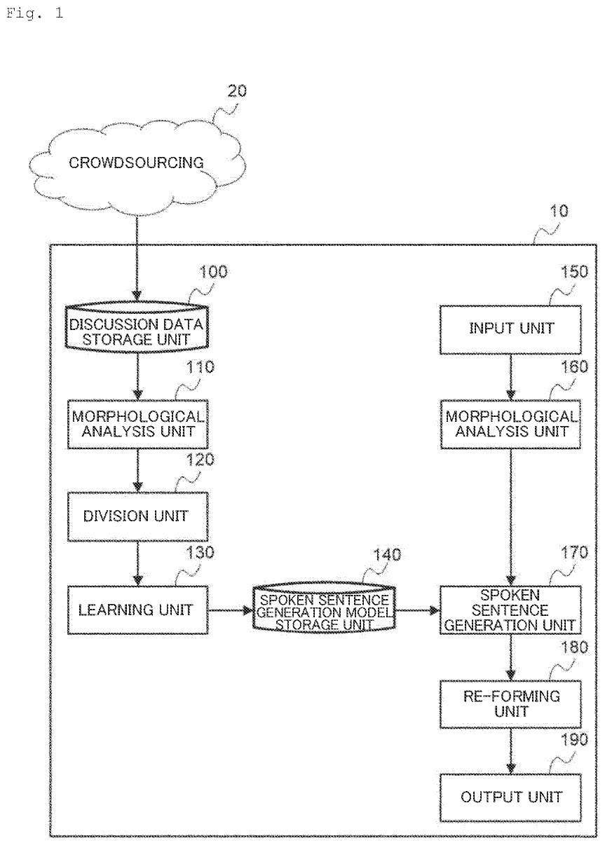

Referring to FIG. 1, a description will be given of a configuration of a spoken sentence generating device 10 according to the embodiment of the present invention. FIG. 1 is a block diagram illustrating the configuration of the spoken sentence generating device 10 according to the embodiment of the present invention.

The spoken sentence generating device 10 is formed of a computer including a CPU, a RAM, and a ROM storing a program for executing a spoken sentence generation processing routine described later, and is functionally configured as described below.

As illustrated in FIG. 1, the spoken sentence generating device 10 according to the present embodiment is configured to include a discussion data storage unit 100, a morphological analysis unit 110, a division unit 120, a learning unit 130, a spoken sentence generation model storage unit 140, an input unit 150, a morphological analysis unit 160, a spoken sentence generation unit 170, a re-forming unit 180, and an output unit 190.

In the discussion data storage unit 100, a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence are stored. The discussion spoken sentence, the approving spoken sentence, and the disapproving spoke sentence are in the same format.

Specifically, the discussion spoken sentences, the approving spoken sentences, and the disapproving spoken sentences are collected by limiting the formats thereof to a format in which a “noun equivalent”, a “particle equivalent”, and a “predicate equivalent” are combined to be stored in the discussion data storage unit 100. This is because spoken sentences required to be dealt with in a discussion cover a wide range of topics.

By limiting the format of the spoken sentences to be collected, it is possible to efficiently collect an entire range of topics to be dealt with in the discussion.

In the format of concern, the “noun equivalent” represents what is to be discussed (theme), and the combination of the “particle equivalent” and the “predicate equivalent” represents an opinion (approval or disapproval) for what is to be discussed.

Since the noun equivalent and the predicate equivalent may also be in a nested structure (e.g., “perspiration”, “is a great relief for stress”), a wide range of spoken sentences can be covered.

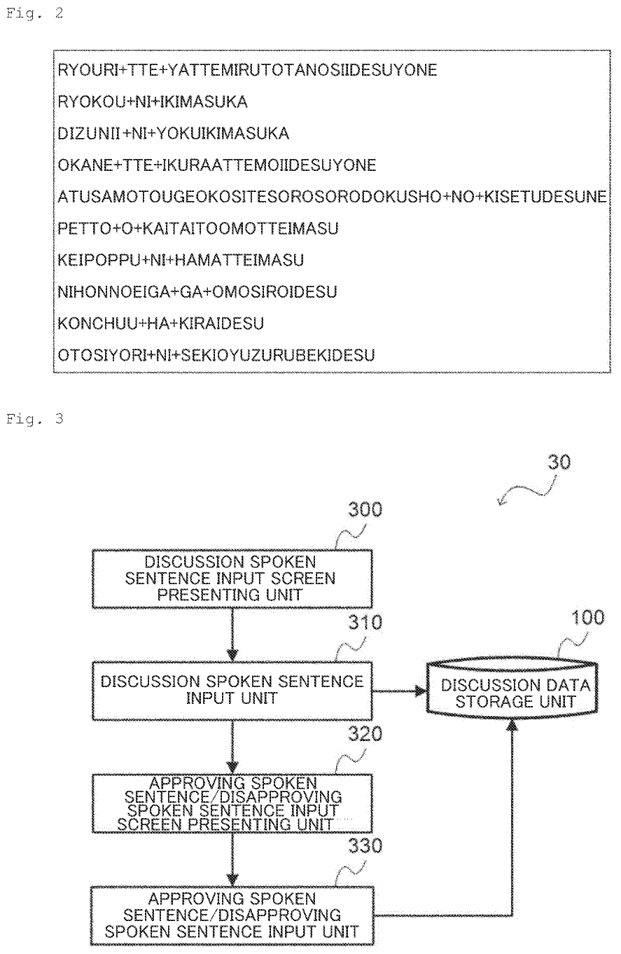

Examples of spoken sentences to be collected are illustrated in FIG. 2. For the sake of description, “+” is interposed between any two of a noun, a particle, and a predicate. The “+” interposed between any two of the noun, the particle, and the predicate is unnecessary when data of the spoken sentences is collected.

Each of the noun and the predicate may include the particle or may also be formed of a plurality of words.

To standardize a way of expression when the spoken sentences are generated, all the sentences preferably end with expressions in a “desu/masu” style.

In accordance with the format described above, the discussion data sets are collected by crowdsourcing 20 (FIG. 1), and the plurality of discussion data sets are stored in the discussion data storage unit 100.

A description is given herein of the collection of the discussion data sets using the crowdsourcing 20. FIG. 3 is a schematic diagram illustrating a configuration of a spoken sentence collecting device 30 disposed on a cloud.

The spoken sentence collecting device 30 receives inputs of the discussion data sets in accordance with the format described above from workers (workers who inputs the discussion data sets) on the cloud and stores the discussion data sets in the discussion data storage unit 100. Note that a description related to communication is omitted.

The spoken sentence collecting device 30 is formed of a computer including a CPU, a RAM, and a ROM storing a program for executing a spoken sentence collection processing routine described later, and is functionally configured as described below.

As illustrated in FIG. 3, the spoken sentence collecting device 30 according to the present embodiment is configured to include the discussion data storage unit 100, a discussion spoken sentence input screen presenting unit 300, a discussion spoken sentence input unit 310, an approving spoken sentence/disapproving spoken sentence input screen presenting unit 320, and an approving spoken sentence/disapproving spoken sentence input unit 330.

The discussion spoken sentence input screen presenting unit 300 presents a screen for the workers to input the discussion spoken sentences.

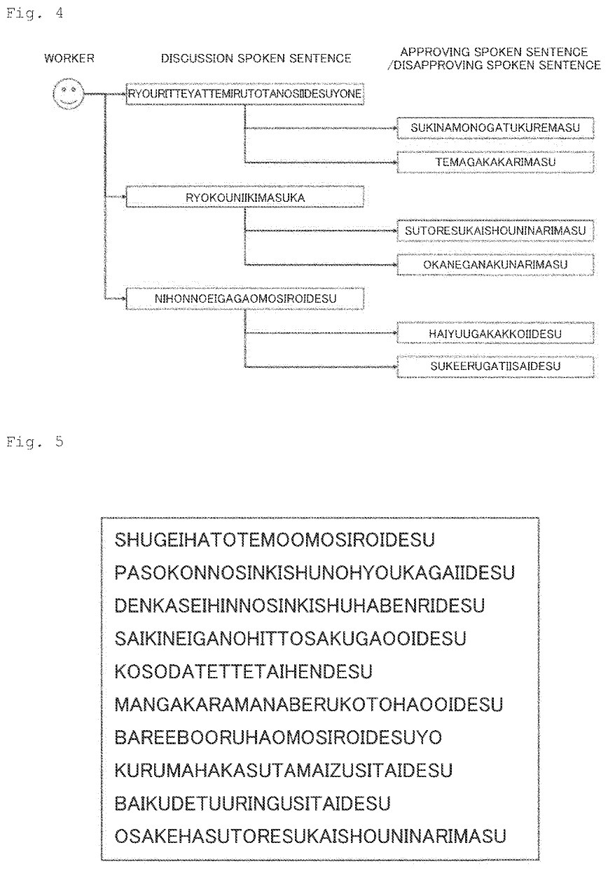

FIG. 4 is a conceptual view illustrating spoken sentences produced by each of the workers for the crowdsourcing and a procedure thereof.

Specifically, the discussion spoken sentence input screen presenting unit 300 presents a screen for each of the workers to input three discussion spoken sentences. As a result, each of the workers first produces three discussion spoken sentences each serving as the discussion topic. The discussion spoken sentences are produced in accordance with the format of the spoken sentences described above.

The discussion spoken sentence input unit 310 displays, on a screen, a message instructing the worker to collect the three sentences including different discussion topics (noun equivalents) to enhance completeness of the spoken sentences to be collected.

The worker is encouraged to freely think about what he or she likes and dislikes, what he or she is interested in, what he or she perceives to be a problem, and the like, and produces the discussion spoken sentences by using what he or she thought of.

Then, the worker inputs the produced discussion spoken sentences via the screen for the worker to input the discussion spoken sentences.

The discussion spoken sentence input unit 310 receives the plurality of discussion spoken sentences input thereto.

Then, the discussion spoken sentence input unit 310 stores the plurality of received discussion spoken sentences in the discussion data storage unit 100.

The approving spoken sentence/disapproving spoken sentence input screen presenting unit 320 presents a screen for the workers to input the approving spoken sentences indicating approval for the input discussion spoken sentences and the disapproving spoken sentences indicating disapproval for the discussion spoken sentences.

Specifically, the approving spoken sentence/disapproving spoken sentence input screen presenting unit 320 presents the screen for the workers to input the approving spoken sentences and the disapproving spoken sentences for each of the three discussion spoken sentences.

As a result, each of the workers produces, for each of the produced discussion spoken sentences, one approving spoken sentence stating a reason for approving the discussion spoken sentence and one disapproving spoken sentence stating a reason for disapproving the discussion spoken sentence each in the same format as that of the discussion spoken sentence.

By producing the approving spoken sentence and the disapproving spoken sentence, it is possible to collect the spoken sentences approving/disapproving the discussion spoken sentence.

Then, the worker inputs the approving spoken sentence and the disapproving spoken sentence each produced thereby via the screen for the worker to input the approving spoken sentence indicating approval for the input discussion spoken sentence and the disapproving spoken sentence indicating disapproval for the input discussion spoken sentence.

The approving spoken sentence/disapproving spoken sentence input unit 330 receives the approving spoken sentence and the disapproving spoken sentence each input thereto.

Then, the approving spoken sentence/disapproving spoken sentence input unit 330 associates the approving spoken sentence and the disapproving spoken sentence each received thereby with the discussion spoken sentence corresponding thereto to provide the discussion data set and stores the discussion data set in the discussion data storage unit 100.

Each of the workers produces the approving spoken sentence and the disapproving spoken sentence for each of the three discussion spoken sentences. As a result, in the discussion data storage unit 100, a total of nine spoken sentences (the three discussion spoken sentences, the three approving spoken sentences, and the three disapproving spoken sentences) produced by the worker are stored.

Thus, the plurality of workers perform this operation by using the spoken sentence collecting device 30 to allow the discussion spoken sentences independent of specific workers and having high completeness and the approving spoken sentences/disapproving spoken sentences therefor to be efficiently collected.

The number of the discussion spoken sentences to be collected is preferably several tens of thousands, and therefore 10,000 or more workers preferably perform the operation. By way of example, a description will be given below of a case where the discussion data sets collected through the operation performed by 15,000 workers are stored in the discussion data storage unit 100.

The morphological analysis unit 110 performs the morphological analysis of each of the spoken sentences included in the discussion data sets.

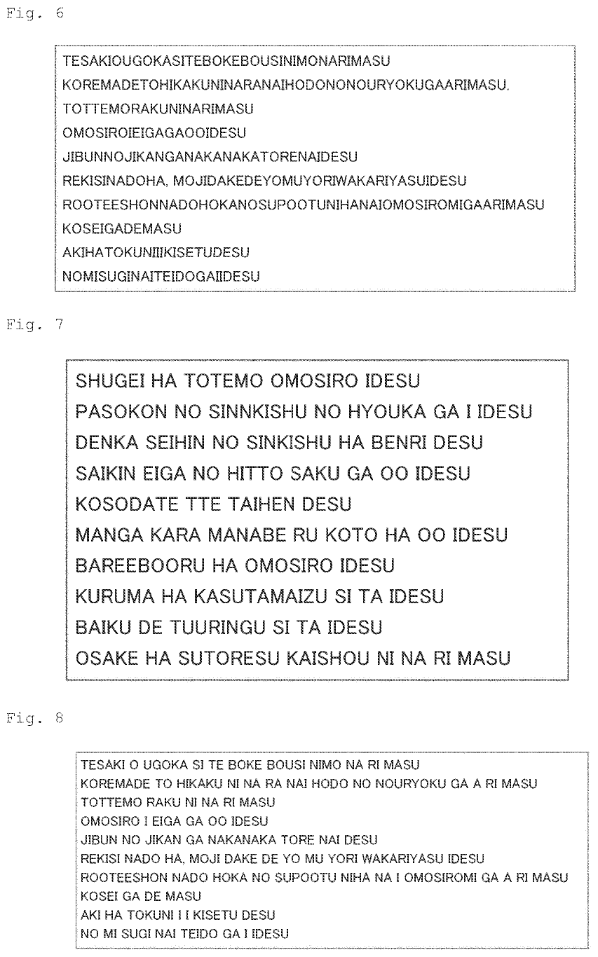

Specifically, the morphological analysis unit 110 first acquires, from the discussion data storage unit 100, a plurality of collected pairs of the discussion spoken sentences and the approving spoken sentences to generate a discussion speech text file in which the discussion spoken sentences are listed in a 1-sentence-per-row format and an approving speech text file in which the approving spoken sentences are listed in the 1-sentence-per-row format, as illustrated in FIGS. 5 and 6.

At this time, each of the pairs of the discussion spoken sentences and the approving spoken sentences are listed in the same row such that a first row corresponds to a first pair, a second row corresponds to a second pair, . . . .

Then, the morphological analysis unit 110 performs morphological analysis of each of the spoken sentences in the respective files in which the discussion spoken sentences and the approving spoken sentences are listed to convert the files to space-separated word-segmented files as illustrated in FIGS. 7 and 8.

For word segmentation, any tool capable of Japanese morphological analysis can be used. As a morphological analyzer, e.g., JTAG (Reference Literature 1) is used.
[Reference Literature 1] T. Fuchi and S. Takagi, Japanese Morphological Analyzer using Word Co-occurrence JTAG, Proc. of COLING-ACL, 1998, pp 409-413.

Likewise, the morphological analysis unit 110 acquires, from the discussion data storage unit 100, a plurality of collected pairs of the discussion spoken sentences and the disapproving spoken sentences to generate the discussion speech text file and a disapproving speech text file in which the disapproving spoken sentences are listed in the 1-sentence-per-row format, performs morphological analysis of the files, and converts the files to the space-separated word-segmented files.

Then, the morphological analysis unit 110 delivers the plurality of word-segmented files to the division unit 120.

The division unit 120 divides the plurality of word-segmented files into training data to be used for learning of the spoken sentence generation model and tuning data.

Specifically, the division unit 120 divides the plurality of word-segmented files into the training data and the tuning data in a predetermined ratio. For example, the division unit 120 adds “train” to a file name of each of the word-segmented files categorized into the training data and adds “dev” to a file name of each of the word-segmented files categorized into the tuning data to demonstrate the division.

As the division ratio, any value can be set, and 9:1 is set herein as the division ratio.

The division unit 120 delivers the training data and the tuning data to the learning unit 130.

The learning unit 130 learns an approving spoken sentence generation model and a disapproving spoken sentence generation model. The learning unit 130 learns, on the basis of the discussion spoken sentences and the approving spoken sentences which are included in the plurality of discussion data sets, the foregoing approving spoken sentence generation model that receives, as the input thereto, the spoken sentence and generates the approving spoken sentence for the spoken sentence. The learning unit 130 learns, on the basis of the discussion spoken sentences and the disapproving spoken sentences which are included in the plurality of discussion data sets, the foregoing disapproving spoken sentence generation model that receives, as the input thereto, the spoken sentence and generates the disapproving spoken sentence for the spoken sentence.

For the approving spoken sentence generation model/disapproving spoken sentence generation model, the same learning method is used herein. Accordingly, a description will be given of learning of the approving spoken sentence generation model.

Specifically, the learning unit 130 can use, for the learning of the approving spoken sentence generation model, any algorithm used in machine translation or the like for learning a model which performs text-to-text conversion. The learning unit 130 can use, e.g., a seq2seq algorithm proposed in Reference Literature 2.
[Reference Literature 2] Vinyals O., Le Q. A neural conversational model, Proceedings of the International Conference on Machine Learning, Deep Learning Workshop, 2015.

The seq2seq in Reference Literature 2 is an algorithm for learning a model which vectorizes a sequence of input symbols to combine the sequence of symbols into one vector and outputs an intended sequence by using the vector.

There are various tools for implementation, and a description will be given herein using OpenNMT-py (Reference literature 3) which is open-source software.
[Reference Literature 3] Guillaume Klein et al., OpenNMT: Open-Source Toolkit for Neural Machine Translation, Proc. ACL, 2017.

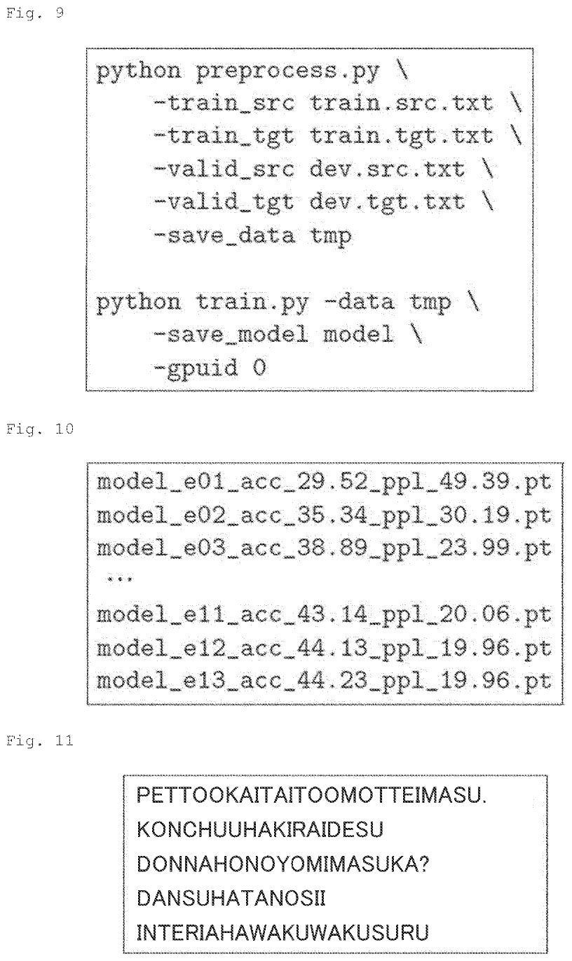

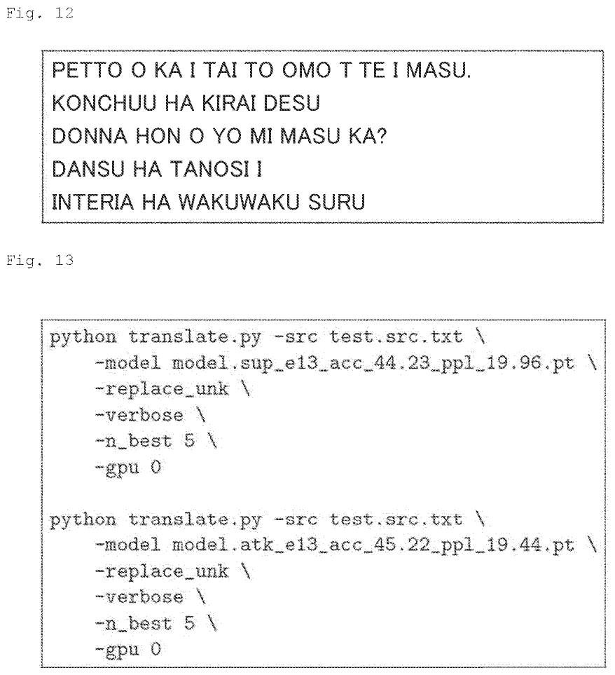

FIG. 9 illustrates an example of a command therefor.

A text file having a file name beginning with “train” indicates the training data, while a text file having a file name beginning with “dev” indicates the tuning data. Meanwhile, a text file having a file name including “src” indicates discussion spoken sentence data, while data having a file name including “tgt” indicates approving spoken sentence data.

“tmp” corresponds to a temporary file, while “model” corresponds to the spoken sentence generation model to be produced.

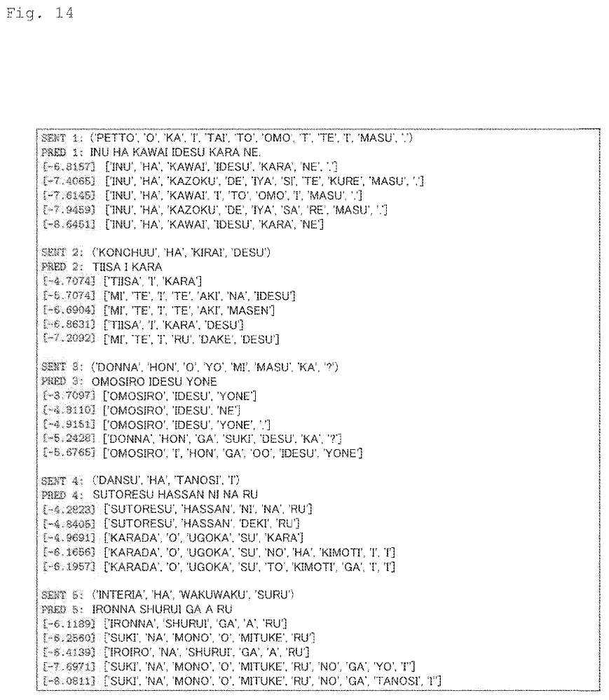

FIG. 10 illustrates an example of a model to be produced.

“e”, “acc”, and “ppl” respectively correspond to the number of epochs (the number of learning loops), accuracy in the training data for the learned model, and perplexity (index indicating a likelihood that the training data is generated by the learned model).

The learning unit 130 adopts a 13th-epoch model having the highest accuracy as the approving spoken sentence generation model.

The learning unit 130 learns the disapproving spoken sentence generation model in the same manner as the learning unit 130 learns the approving spoken sentence generation model.

Then, the learning unit 130 stores the approving spoken sentence generation model and the disapproving spoken sentence generation model each having the highest accuracy in the spoken sentence generation model storage unit 140.

In the spoken sentence generation model storage unit 140, the learned approving spoken sentence generation models and the learned disapproving spoken sentence generation models are stored.

The input unit 150 receives a user spoken sentence input thereto.

Specifically, the input unit 150 receives, as an input thereto, the user spoken sentence in a text format. FIG. 11 illustrates an example of the input user spoken sentence. Each row corresponds to the input user spoken sentence.

Then, the input unit 150 delivers the received user spoken sentence to the morphological analysis unit 160.

The morphological analysis unit 160 performs the morphological analysis of the user spoken sentence received by the input unit 150.

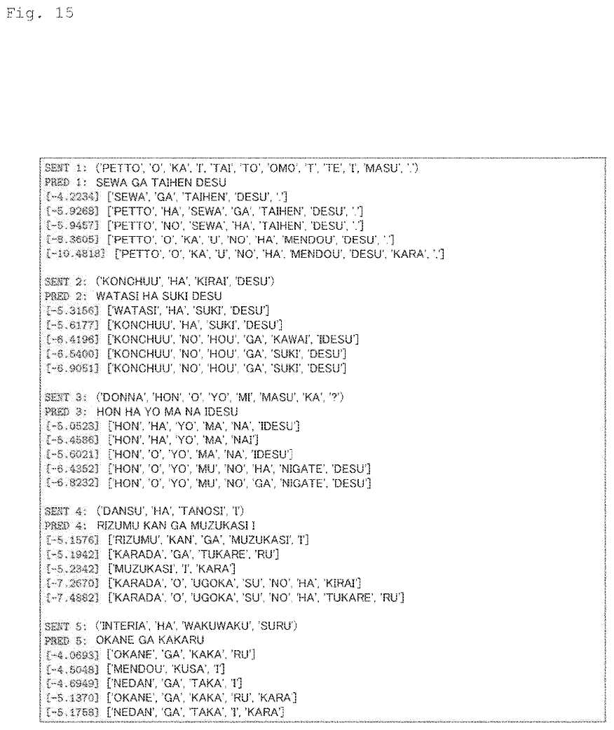

Specifically, the morphological analysis unit 160 performs the morphological analysis of the user spoken sentence to convert the user spoken sentence to a space-separated word-segmented sentence as illustrated in FIG. 12.

To convert the user spoken sentence to the word-segmented sentence, the same morphological analyzer (e.g., JTAG (Reference Literature 1)) as the morphological analysis unit 110 is used herein.

FIG. 12 illustrates an example of a word-segmented file resulting from conversion of a plurality of the user spoken sentences to word-segmented sentences. The word-segmented sentences illustrated in individual rows of the word-segmented file correspond to the individual user spoken sentences.

Then, the morphological analysis unit 160 delivers the word-segmented sentences to the spoken sentence generation unit 170.

The spoken sentence generation unit 170 receives, as an input thereto, each of the word-segmented sentences and generates the approving spoken sentences and the disapproving spoken sentences by using the approving spoken sentence generation model and the disapproving spoken sentence generation model.

Specifically, the spoken sentence generation unit 170 first acquires, from the spoken sentence generation model storage unit 140, the learned approving spoken sentence generation model and the learned disapproving spoken sentence generation model.

Next, the spoken sentence generation unit 170 inputs the word-segmented sentences to the approving spoken sentence generation model and the disapproving spoken sentence generation model to generate the approving spoken sentences and the disapproving spoken sentences.

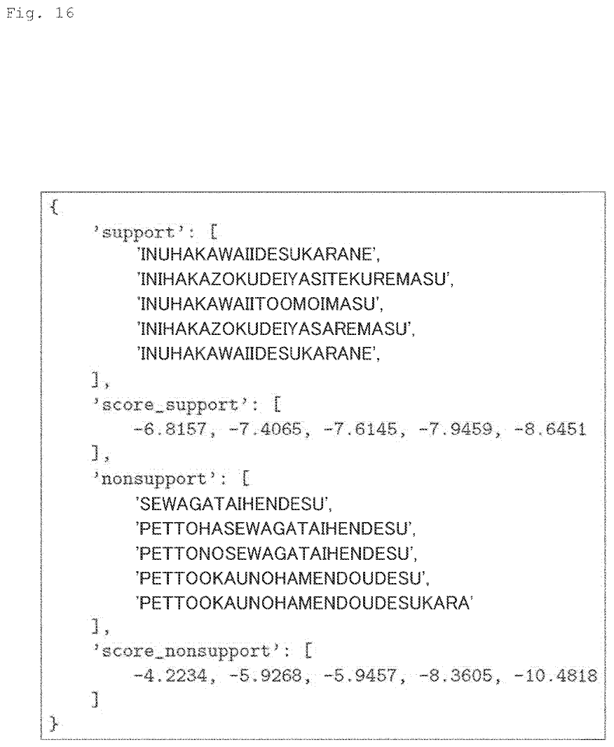

FIG. 13 illustrates an example of commands to generate spoken sentences. “test. src. txt” is a file (FIG. 12) in which the user spoken sentences converted to the word-segmented sentences are written.

A first command in an upper portion of FIG. 13 is a command for generating the approving spoken sentences, while a second command in a lower portion of FIG. 13 is a command for generating the disapproving spoken sentences. Note that meanings of options for these commands are described in Reference Literature 3.

Here, commands for outputting five higher-scored approving spoken sentences and five higher-scored disapproving spoken sentences are described. However, any number can be specified therefor.

The spoken sentence generation unit 170 executes such a first command and a second command to generate the plurality of approving spoken sentences and the plurality of disapproving spoken sentences.

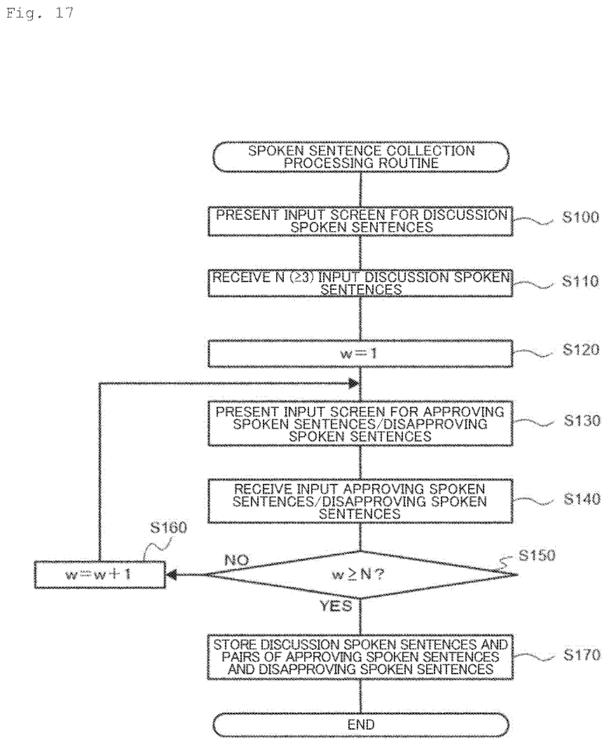

FIG. 14 illustrates an example of a result of generating the approving spoken sentences. FIG. 15 illustrates an example of a result of generating the disapproving spoken sentences. It can be recognized that, for the input user spoken sentences, appropriate approving spoken sentences and disapproving spoken sentences were generated.

Then, the spoken sentence generation unit 170 delivers the plurality of generated approving spoken sentences and disapproving spoken sentences to the re-forming unit 180.

The re-forming unit 180 re-forms the approving spoken sentences and disapproving spoken sentences that are generated by the spoken sentence generation unit 170 into a predetermined format.

Specifically, the re-forming unit 180 re-forms the plurality of generated approving spoken sentences and disapproving spoken sentences into any given format.

Any given format can be used and, e.g., a JSON format can be adopted. It is assumed that, in the present embodiment, the JSON format is used.

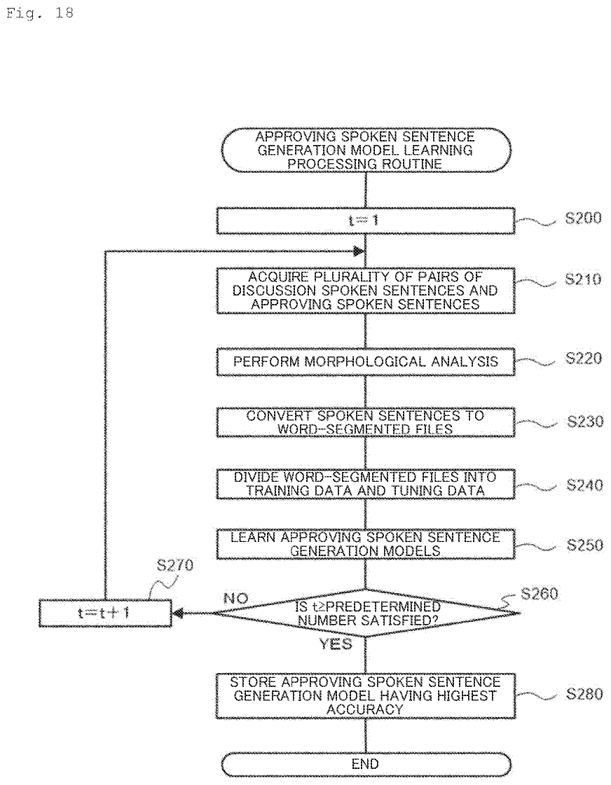

FIG. 16 illustrates an example of the approving spoken sentences/disapproving spoken sentences generated by the spoken sentence generation unit 170 and re-formed by the re-forming unit 180 when the input user spoken sentence is “PETTOOKAITAITOOMOTTEIMASU”.

As illustrated in FIG. 16, the five higher-scored approving spoken sentences and the five higher-scored disapproving spoken sentences (when M=5) that are generated by the spoken sentence generation unit 170 and the respective scores thereof are sequentially arranged. In addition, “support”, “score support”, “nonsupport”, and “score nonsupport” represent the approving spoken sentences, the scores of the approving spoken sentences (logarithms of generation probabilities), the disapproving spoken sentences, and the scores of the disapproving spoken sentences (logarithms of generation probabilities).

Then, the re-forming unit 180 delivers the plurality of re-formed approving spoken sentences and disapproving spoken sentences to the output unit 190.

The output unit 190 outputs the plurality of approving spoken sentences and disapproving spoken sentences that are re-formed by the re-forming unit 180.

By using this output, the dialogue system (not shown) can output, for the user spoken sentence of “PETTOOKAITAITOOMOTTEIMASU”, an approving spoken sentence of, e.g., “INUHAKAWAIIDESUKARANE” or output a disapproving spoken sentence of, e.g., “SEWAGATAIHENDESU”.

<Operation of Spoken Sentence Collecting Device According to Embodiment of Present Invention>

FIG. 17 is a flowchart illustrating the spoken sentence collection processing routine according to the embodiment of the present invention. In the spoken sentence collecting device 30, the spoken sentence collection processing routine is executed.

In Step S100, the discussion spoken sentence input screen presenting unit 300 presents the screen for causing the workers to input the discussion spoken sentences.

In Step S110, the discussion spoken sentence input unit 310 receives the plurality of discussion spoken sentences input thereto.

In Step S120, the spoken sentence collecting device 30 sets w to 1 where w is a counter herein.

In Step S130, the approving spoken sentence/disapproving spoken sentence input screen presenting unit 320 presents the screen for the workers to input the approving spoken sentences indicating approval for a w-th input discussion spoken sentence and the disapproving spoken sentences indicating disapproval for the w-th discussion spoken sentence.

In Step S140, the approving spoken sentence/disapproving spoken sentence input unit 330 receives the approving spoken sentences and the disapproving spoken sentences that are input thereto.

In Step S150, the spoken sentence collecting device 30 determines whether or not w≥N is satisfied (N is the number of the input discussion spoken sentences and is, e.g., 3).

When w≥N is not satisfied (NO in Step S150 described above), in Step S160, the spoken sentence collecting device 30 adds 1 to w, and returns to S130.

Meanwhile, when w≥N is satisfied (YES in Step S150 described above), in Step S170, the approving spoken sentence/disapproving spoken sentence input unit 330 associates N approving spoken sentences and N disapproving spoken sentences that are received in Step S140 described above with the discussion spoken sentences corresponding thereto and stores the N approving spoken sentences and N disapproving spoken sentences associated with the discussion spoken sentences as the discussion data sets in the discussion data storage unit 100.

<Operation of Spoken Sentence Generating Device According to Embodiment of Present Invention>

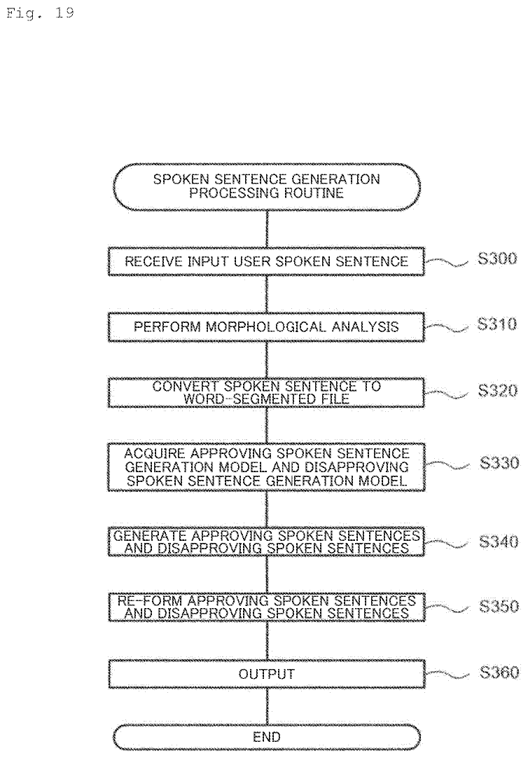

FIG. 18 is a flowchart illustrating the spoken sentence generation model learning processing routine according to the embodiment of the present invention.

When learning processing is started, in the spoken sentence generating device 10, the spoken sentence generation processing routine illustrated in FIG. 18 is executed.

In Step S200, the spoken sentence generating device 10 sets t to 1, and t is a counter herein.

In Step S210, the morphological analysis unit 110 first acquires, from the discussion data storage unit 100, the plurality of collected pairs of the discussion spoken sentences and the approving spoken sentences.

In Step S220, the morphological analysis unit 110 performs the morphological analysis of each of spoken sentences in files in which the discussion spoken sentences/approving spoken sentences are listed.

In Step S230, the morphological analysis unit 110 converts, to the space-separated word-segmented files, the individual spoken sentences in the files having the lists of the discussion spoken sentences/approving spoken sentences after subjected to the morphological analysis performed in Step S230 described above.

In Step S240, the division unit 120 divides the plurality of word-segmented files into the training data to be used for learning of the spoken sentence generation model and the tuning data.

In Step S250, the learning unit 130 learns, on the basis of the discussion spoken sentences and the approving spoken sentences that are included in the plurality of discussion data sets, the approving spoken sentence generation models that receive, as inputs thereto, the spoken sentences and generate the approving spoken sentences for the spoken sentences.

In Step S260, the spoken sentence generating device 10 determines whether or not t≥Predetermined Number is satisfied. The predetermined number mentioned herein is the number of times learning is repeated.

When t≥Predetermined Number is not satisfied (NO in Step S260 described above), in Step S270, the spoken sentence generating device 10 adds 1 to t, and returns to Step S210.

Meanwhile, when t≥Predetermined Number is satisfied (YES in Step S260 described above), in step S280, the learning unit 130 stores the approving spoken sentence generation model having the highest accuracy in the spoken sentence generation model storage unit 140.

Likewise, by performing processing in Steps S200 to S280 described above for the disapproving spoken sentences, the learning unit 130 learns the disapproving spoken sentence generation models that receive, as inputs thereto, the spoken sentences and generate the disapproving spoken sentences for the spoken sentences, and stores the disapproving spoken sentence generation model having the highest accuracy in the spoken sentence generation model storage unit 140.

FIG. 19 is a flowchart illustrating the spoken sentence generation processing routine according to the embodiment of the present invention.

When the user speech is input to the input unit 150, in the spoken sentence generating device 10, the spoken sentence generation processing routine illustrated in FIG. 19 is executed.

In Step S300, the input unit 150 receives the user spoken sentence input thereto.

In Step S310, the morphological analysis unit 160 performs the morphological analysis of the user spoken sentence received in Step S300 described above.

In Step S320, the morphological analysis unit 160 converts the user spoken sentence subjected to the morphological analysis in Step S310 described above to a space-separated word-segmented sentence.

In Step S330, the spoken sentence generation unit 170 acquires, from the spoken sentence generation model storage unit 140, the approving spoken sentence generation model and the disapproving spoken sentence generation model that have been learned.

In Step S340, the spoken sentence generation unit 170 inputs the word-segmented sentences to the approving spoken sentence generation model and the disapproving spoken sentence generation model to generate the approving spoken sentences and the disapproving spoken sentences.

In Step S350, the re-forming unit 180 re-forms the approving spoken sentences and disapproving spoken sentences generated in Step S340 described above into those in a predetermined format.

In Step S360, the output unit 190 outputs the plurality of approving spoken sentences and disapproving spoken sentences re-formed in Step S350 described above.

As described above, in the spoken sentence generating device according to the embodiment of the present invention, the plurality of discussion data sets each including the discussion spoken sentence indicating the discussion topic and the pair of the approving spoken sentence indicating approval for the discussion spoken sentence and the disapproving spoken sentence indicating disapproval for the discussion spoken sentence are stored. In addition, the spoken sentence generating device according to the embodiment of the present invention learns, on the basis of the discussion spoken sentences and the approving spoken sentences that are included in the plurality of discussion data sets, the approving spoken sentence generation model that receives, as an input thereto, the spoken sentence and generates the approving spoken sentences for the spoken sentence. The spoken sentence generating device according to the embodiment of the present invention also learns, on the basis of the discussion spoken sentences and the disapproving spoken sentences that are included in the plurality of discussion data sets, the disapproving spoken sentence generation model that receives, as an input thereto, the spoken sentence and generates the disapproving spoken sentences for the spoken sentence. Thus, the spoken sentence generating device according to the embodiment of the present invention can learn the spoken sentence generation model for generating a spoken sentence which enables a discussion covering a wide range of topics.

Meanwhile, a spoken sentence collecting device according to the embodiment of the present invention presents a screen for a worker to input a discussion spoken sentence indicating a discussion topic and receives the discussion spoken sentence input thereto. In addition, the spoken sentence collecting device according to the embodiment of the present invention presents a screen for the worker to input an approving spoken sentence indicating approval for the input discussion spoken sentence and a disapproving spoken sentence indicating disapproval for the discussion spoken sentence, and receives the input approving spoken sentence and the input disapproving spoken sentence. The spoken sentence collecting device according to the embodiment of the present invention also stores a discussion data set including the input discussion spoken sentence and a pair of the approving spoken sentence for the discussion spoken sentence and the disapproving spoken sentence for the discussion spoken sentence. In the description given above, the discussion spoken sentence, the approving spoken sentence, and the disapproving spoken sentence are in the same format. This allows the spoken sentence collecting device according to the embodiment of the present invention to efficiently collect the discussion data sets for learning a spoken sentence generation model that generates a spoken sentence which enables a discussion covering a wide range of topics.

Specifically, by limiting the format of the discussion data sets to be collected and using crowdsourcing, it is possible to efficiently collect the discussion data sets capable of covering a wide range of topics.

In addition, in building of a dialogue system, the format of the discussion data sets is limited to allow generation-based spoken sentence generation using deep learning to be applied thereto. As a result, a robust argumentative dialogue system less likely to be affected by words or wording is built.

Note that the present invention is not limited to the embodiment described above, and various modifications and applications are possible within a scope not departing from the gist of this invention.

For example, in the embodiment described above, the case where one spoken sentence generating device is configured to perform the learning of the approving spoken sentence generation model and the disapproving spoken sentence generation model as well as the generation of the spoken sentences is described by way of example, but the embodiment is not limited thereto. The embodiment may also be configured such that a spoken sentence generating device that performs the generation of the spoken sentences and a spoken sentence generation model learning device that performs the learning of the approving spoken sentence generation model and the disapproving spoken sentence generation model are provided as separate devices.

In the description of the present application, the embodiment in which the program is installed in advance is described, but it is also possible to provide the program which is stored on a computer readable recording medium.

### REFERENCE SIGNS LIST

10 Spoken sentence generating device
20 Crowdsourcing
30 Spoken sentence collecting device
100 Discussion data storage unit
110 Morphological analysis unit
120 Division unit
130 Learning unit
140 Spoken sentence generation model storage unit
150 Input unit
160 Morphological analysis unit
170 Spoken sentence generation unit
180 Re-forming unit
190 Output unit
300 Discussion spoken sentence input screen presenting unit
310 Discussion spoken sentence input unit
320 Approving spoken sentence/disapproving spoken sentence input screen presenting unit
330 Approving spoken sentence/disapproving spoken sentence input unit

1. A spoken sentence generation model learning device comprising:
a discussion data store configured to store a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence, the discussion spoken sentence, the approving spoken sentence, and the disapproving spoken sentence being in the same format; and
a learner configured to learn, on the basis of the discussion spoken sentences and the approving spoken sentences that are included in the plurality of discussion data sets, an approving spoken sentence generation model that receives, as an input thereto, a spoken sentence and generates the approving spoken sentence for the spoken sentence and also learns, on the basis of the discussion spoken sentences and the disapproving spoken sentences that are included in the plurality of discussion data sets, a disapproving spoken sentence generation model that receives, as an input thereto, the spoken sentence and generates the disapproving spoken sentence for the spoken sentence.

2. The spoken sentence generation model learning device according to claim 1, wherein the format of each of the discussion spoken sentence, the approving spoken sentence, and the disapproving spoken sentence includes a format in which a noun equivalent, a particle equivalent, and a predicate equivalent are combined.

3. A spoken sentence collecting device comprising:
a discussion spoken sentence input screen presenter configured to present a screen for a worker to input a discussion spoken sentence indicating a discussion topic;
a discussion spoken sentence receiver configured to receive the input discussion spoken sentence; an approving spoken sentence/disapproving spoken sentence input screen presenter configured to present a screen for the worker to input an approving spoken sentence indicating approval for the input discussion spoken sentence and a disapproving spoken sentence indicating disapproval for the discussion spoken sentence;
an approving spoken sentence/disapproving spoken sentence receiver configured to receive the input approving spoken sentence and the input disapproving spoken sentence; and
a discussion data store configured to store a discussion data set including the input discussion spoken sentence and a pair of the approving spoken sentence for the discussion spoken sentence and the disapproving spoken sentence for the discussion spoken sentence, wherein the discussion spoken sentence, the approving spoken sentence, and the disapproving spoken sentence are in the same format.

4. A method, the method comprising:
storing, by a discussion data store, a plurality of discussion data sets each including a discussion spoken sentence indicating a discussion topic and a pair of an approving spoken sentence indicating approval for the discussion spoken sentence and a disapproving spoken sentence indicating disapproval for the discussion spoken sentence;
learning, by a learner on the basis of the discussion spoken sentences and the approving spoken sentences that are included in the plurality of discussion data sets, an approving spoken sentence generation model that receives, as an input thereto, a spoken sentence and generates the approving spoken sentence for the spoken sentence and also learning, on the basis of the discussion spoken sentences and the disapproving spoken sentences that are included in the plurality of discussion data sets, a disapproving spoken sentence generation model that receives, as an input thereto, the spoken sentence and generates the disapproving spoken sentence for the spoken sentence.

5. The method of claim 4, the method further comprising:
presenting, by a discussion spoken sentence input screen presenter, a screen for a worker to input the discussion spoken sentence indicating a discussion topic;
receiving, by a discussion spoken sentence receiver, the input discussion spoken sentence;
presenting, by an approving spoken sentence/disapproving spoken sentence input screen presenter, a screen for the worker to input the approving spoken sentence indicating the approval for the input discussion spoken sentence and the disapproving spoken sentence indicating the disapproval for the discussion spoken sentence, receiving, by an approving spoken sentence/disapproving spoken sentence receiver, the input approving spoken sentence and the input disapproving spoken sentence, and storing, by the discussion data store, the discussion data set including the input discussion spoken sentence and the pair of the approving spoken sentence for the discussion spoken sentence and the disapproving spoken sentence for the discussion spoken sentence, wherein the discussion spoken sentence, the approving spoken sentence, and the disapproving spoken sentence are in the same format.

6. (canceled)

7. The spoken sentence generation model learning device according to claim 2, wherein the noun equivalent represents a discussion theme, wherein a combination of the particle equivalent and the predicate equivalent represents an opinion, and wherein the opinion includes one of the approval or the disapproval for the discussion theme.

8. The spoken sentence generation model learning device according to claim 2, wherein a combination of the noun equivalent and the predicate equivalent forms a nested structure.

9. The spoken sentence generation model learning device according to claim 2, wherein the plurality of discussion data sets includes a plurality of discussion topics based on use of crowdsourcing.

10. The spoken sentence generation model learning device according to claim 2, wherein a combination of the approving spoken sentence generation model and the disapproving spoken sentence generation model is based on deep learning.

11. The spoken sentence generation model learning device according to claim 2, wherein the generated approving spoken sentence for the spoken sentence is associated with a probability score.

12. The spoken sentence collecting device according to claim 3, wherein the format of each of the discussion spoken sentence, the approving spoken sentence, and the disapproving spoken sentence is a format in which a noun equivalent, a particle equivalent, and a predicate equivalent are combined.

13. The spoken sentence collecting device according to claim 12, wherein the noun equivalent represents a discussion theme, wherein a combination of the particle equivalent and the predicate equivalent represents an opinion, and wherein the opinion includes one of an approval or a disapproval for the discussion theme.

14. The spoken sentence collecting device according to claim 12, wherein a combination of the noun equivalent and the predicate equivalent forms a nested structure.

15. The spoken sentence collecting device according to claim 12, wherein the plurality of discussion data sets includes a plurality of discussion topics based on use of crowdsourcing.

16. The spoken sentence collecting device according to claim 12, wherein a combination of the approving spoken sentence generation model and the disapproving spoken sentence generation model is based on deep learning.

17. The spoken sentence collecting device according to claim 12, wherein the generated approving spoken sentence for the spoken sentence is associated with a probability score.

18. The method according to claim 4, wherein the format of each of the discussion spoken sentence, the approving spoken sentence, and the disapproving spoken sentence is a format in which a noun equivalent, a particle equivalent, and a predicate equivalent are combined.

19. The method according to claim 4, wherein the noun equivalent represents a discussion theme, wherein a combination of the particle equivalent and the predicate equivalent represents an opinion, and wherein the opinion includes one of the approval or the disapproval for the discussion theme.

20. The method according to claim 4, wherein the plurality of discussion data sets includes a plurality of discussion topics based on use of crowdsourcing.

21. The method according to claim 5, wherein the format of each of the discussion spoken sentence, the approving spoken sentence, and the disapproving spoken sentence is a format in which a noun equivalent, a particle equivalent, and a predicate equivalent are combined.
